(19) United States
(12) Patent Application Publication
(10) Pub. No.: US 2009/0287783 A1
(43) Pub. Date: Nov. 19, 2009

(54) METHOD OF SOCIAL INTERACTION BETWEEN COMMUNICATION DEVICE USERS

(75) Inventors: Christopher Thomas Beare, New South Wales (AU); John Ricketts, New South Wales (AU); Howard Adam Salzer, New South Wales (AU)

Correspondence Address: THE OLLILA LAW GROUP LLC, 2060 BROADWAY, SUITE 300, BOULDER, CO, 80302, US

(73) Assignee: ECCOSPHERE INTERNATIONAL PTY LTD., an Australian c, Adelaide (AU)

(21) Appl. No.: 12/306,428

(22) PCT Filed: Jun. 29, 2007
(86) PCT No.: PCT/AU2007/000911

§ 371 Date: Apr. 8, 2009

(30) Foreign Application Priority Data
Jun. 30, 2006 (AU) 2006903534

(51) Int. Cl. G06F 15/16; G06F 3/048; G06F 17/30; G06F 7/06

(52) U.S. Cl. 709/206; 715/757; 707/10; 707/E17.032

(57) ABSTRACT

A method of social interaction between communication device users across a network (14, 16), the method including: at a first communication device (18, 20), selecting a user communication group of a communication group type corresponding to one of: (a) a known user; (b) a group of users with a previously established relationship; or (c) a group of users with no previously established relationship; and communicating with users in the selected communication group.

### TECHNICAL FIELD

The present invention relates generally to communication between users across a communication network, and in particular to enabling shared group interactions between communication device users. The invention is suitable for use in applications involved communications between users of mobile communication devices, and it will be convenient to describe the invention in relation to those exemplary, but non-limiting, applications.

### BACKGROUND

Communications between individuals are increasingly taking place between networked computers and other communication devices. The widespread availability of the Internet has enabled individuals to take advantage of instant messaging and video conferencing applications to engage in one-on-one real-time electronic communications. Cellular telephones and other mobile communication devices have also provided users with real time speech, text and video communication tools for real-time electronic communication.

Whilst they have been widely adopted for use between individuals having a pre-existing relationship, these tools are nevertheless not well suited to a wide variety of social interactions. Although mobile communication devices can enable conference calls with multiple individuals, there exist no applications that are designed to enable mobile communications devices to be used in ways that are consistent with face-to-face group social interactions.

There exists a need for users of mobile communication devices to be able to interact in a way that mirrors normal social interaction. For example, people form clubs, groups or gangs in society. Crowds form and disband, people overhear conversations and join in, individuals form close alliances with other individuals in marriage or partnerships, families and gangs develop their own verbal and non-verbal communication methods. These and other communication opportunities are currently unable to be replicated in communications between users of mobile communication devices.

Much of the use of mobile communication devices today is rule driven by operators and handset manufacturers. Currently typical communications between mobile phones are one-to-one and interrupt driven; a cellular telephone rings, and the user must cease all other activity and answer the incoming call exclusively. This is not a natural way for people to communicate in society.

There exists a need to provide a method of social interaction between users of mobile communication devices that is consistent with face-to-face group social interactions. There also exists a need to provide a method of social interaction between mobile communication device users that is simple to use, flexible and suited to a variety of different group interaction circumstances. There also exists a need to provide a method of social interaction between mobile communication device users that ameliorates or overcomes one or more disadvantages of known mobile communication device interaction techniques.

### SUMMARY

One aspect of the invention provides a method of social interaction between communication device users across a network, the method including, at a first communication device, selecting a user communication group of a first communication group type corresponding to one of: (a) a known user; (b) a group of users with a previously established relationship; or (c) users in a group of users with no previously established relationship; and communicating with users in the selected communication group.

A social interaction method including the steps is simple and intuitive and meets the social interaction needs of users of communication devices in a way that reflects social interactions in physical spaces.

The communicating step of the social interaction method preferably includes one or both of sending communications to users in the selected communications group; or receiving communications from users in the selected communication group.

The user communication group may be selected by selecting a user communication group type; and selecting a user communication group matching that user communication group type.

The social interaction method may further include the step of, at the first communication device, presenting an indication of the user communication groups available for selection.

The method may further include the step of, upon selection of a user communication group, presenting an indication of available communication methods for interaction within the selected user communication group.

In one embodiment, users in a communication group of type (c) are known to be within a defined geographical zone. The geographical zone may be defined by the location of the first communication device.

A communication within a user communication group of type (c) may be accompanied by metadata identifying one or more characteristics of the communication. Typically, the metadata may characterise at least one of media type or one or more textual elements of the communication.

The social interaction method may further include the step of enabling user selection of the metadata at the first mobile communication device.

The social interaction method may further include the step of using a communication tool for communicating with users in the selected communication group. Preferably, the communication tools provided for communication with users in user communication groups of types (a), (b) and (c) are consistent with each other.

For a user communication group of type (a), the communication group tool provides at least an indication of the user communication group; and one or more network addresses to enable communication with the known persons communication device.

For a user communication group of type (b), the communication tool preferably provides at least an indication of the user communication group; and one or more network addresses to enable communication with all users in the communication group.

For a user communication group of type (c), the communication tool may provide at least an indication of the user communication group. In embodiments of the invention where users are known to be within a defined geographical zone, the communication tool may also enable user selection of the extent of the defined geographical zone. The communication tool for a user communication group of type (c) may further include one or more user selected rules to enable selective reception of communications from communication devices of users in the communication group.

The method may further include the step of using the first communications device to create the communication tool. Alternatively, the method may further include the step of using a communications device not forming part of the selected communication group to create the communication tool.

The social interaction method may further include the step of notifying one or more other users in the user communication group of the creation of the communication tool.

The social interaction method may further include the step of transmitting the communication tool to users of other mobile communication devices in the user communication group.

Another aspect of the invention includes a communication device including a processor and associated memory for storing a series of instructions to cause the processor to perform the steps of the above described method.

Another aspect of the invention provides a system for enabling social interaction between communication device users across a network, the system including one or more communication devices and one or more servers for facilitating interaction between the communication devices. In this context, the term server is intended to refer to individual servers or clusters of servers.

Another aspect of the invention provides a server for use in the above described social interaction system, the server including a processor and associated memory for storing a series of instructions to cause the processor to facilitate interaction between the communication devices.

In one or more embodiments of the invention, one or more users are a virtual persona. A plurality of personas may be associated with a same communications device. In this case, the method may further including the step of: selecting one of the personas for communication with the selected communication group.

Another aspect of the invention provides a communication device including a processor and an associated memory for storing software that causes the processor to carry out a method described above.

Yet another aspect of the invention provides software for use with a communication device including a processor and an associated memory for storing the software, the software including a series of instructions that causes the processor to carry out a method according to any one of the preceding claims.

A further aspect of the invention provides a method for facilitating social interaction between communication device users across a network, wherein at least a first communication device is configure to enable (i) selection of a user communication group of a communication group type corresponding to one of (a) a known user, (b) users in a group of users with a previously established relationship or (c) users in a group of users with no previously established relationship; and (ii) communication with communication devices of users in the selected communication group, the method including: at a server, receiving from the first communication device data identifying all users in a communication group; creating a communication tool associated with the communication group; and transmitting the communication tool to the first communication device for use in selection of and communicating with the communication group.

The method may further include the step of: transmitting the communication tool to other users in the communication group.

Yet another aspect of the invention provides a method for facilitating social interaction between communication device users across a network, wherein at least a first communication device is configure to enable (i) selection of a user communication group of a communication group type corresponding to one of (a) a known user, (b) a group of users with a previously established relationship or (c) a group of users with no previously established relationship; and (ii) communication with communication devices of users in the selected communication group, the method including: at a server, receiving from the first communication device data identifying the spatial context of the communication group of type (c); and transmitting communications from within that spatial context to the first communication device.

The method may further include the step of: at the server, receiving from the first communication device rules for filtering communications transmitted to the first communication device; and selectively transmitting communications from within that spatial context to the first communication device.

The method may further include the step of: transmitting a communication tool to one or more users in the group in order to enable reception of a same set of communications by those users.

A further aspect of the invention provides a server including a processor and an associated memory for storing software that causes the processor to carry out a method described above.

Yet another aspect of the invention provides software for use with a server including a processor and an associated memory for storing the software, the software including a series of instructions that causes the processor to carry out a method described above.

### BRIEF DESCRIPTION OF THE DRAWINGS

Embodiments of the invention will now be described by way of example only with reference to the accompanying drawings in which:

FIG. 1 is a schematic diagram showing one embodiment of a system of social interaction between mobile communication device users;

FIG. 2 is a schematic diagram of one of the mobile devices forming part of the system shown in FIG. 1;

FIG. 3 is a schematic diagram showing various elements of a server forming part of the system depicted in FIG. 1;

FIGS. 4 to 7 are schematic diagrams illustrating different communication groups with which a mobile communication device user forming part of the system shown in FIG. 1 is able to interact;

FIG. 8 is a representation of a user interface of one of the mobile communication devices forming part of the system of FIG. 1;

FIG. 9 is a flow chart illustrating the manner in which different displays may be presented to the user via the user interface shown in FIG. 7;

FIGS. 10 and 11 are exemplary displays provided to the user of a mobile communications device forming part of the system shown in FIG. 1 during communication with the communication groups shown in FIGS. 3 to 6;

FIG. 12 is a flow chart showing operation of the various elements of the system of FIG. 1 during the establishment of a communication group of the type shown in FIG. 4;

FIG. 13 is a flow chart showing the operation of the various elements of the system of FIG. 1 during communication with a communication group of the type shown in FIG. 4;

FIG. 14 is a flow chart showing operation of the various elements of the system shown in FIG. 1 during establishment of a communication group of a type shown in FIG. 5;

FIG. 15 is a flow chart showing operation of elements of the system of FIG. 1 during communication with a communication group of the type shown in FIG. 5;

FIG. 16 is a flow chart showing operation of elements of the system of FIG. 1 during establishment of a communication group of the type shown in FIGS. 6 and 7; and

FIG. 17 is a flow chart showing operation of elements of the system shown in FIG. 1 during communication with a communication group of the type shown in FIGS. 6 and 7.

### DETAILED DESCRIPTION

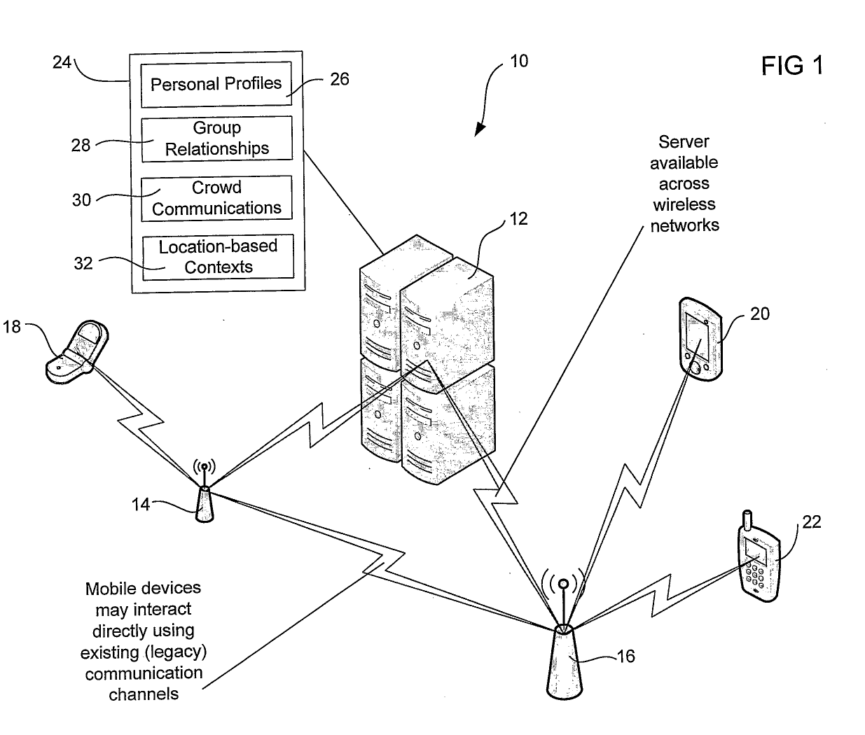

Referring now to FIG. 1, there is shown generally an exemplary embodiment of a system 10 for enabling social interaction between users of mobile communication devices. System 10 includes a server or server cluster 12, telecommunication carriers 14 and 16 and mobile communication devices 18, 20 and 22. Peer-to-peer connections that directly link the mobile communications devices 18, 20 and 22 are able to be established via the telecommunication carriers 14 and 16. Server-based connections are also able to be established between the server 12 and the mobile communication devices 18, 20 and 22 in order to enable various functional aspects of social interaction mechanisms between the users of the mobile communication devices 18, 20 and 22.

The server 12, telecommunication carriers 14 and 16, the mobile communication devices 18, 20 and 22 and the connections between them may conform to any suitable telecommunications protocol, such as GSM or W-CDMA. The peer-to-peer and server-based connections between elements of the system 10 shown in FIG. 1 may support voice, data, video or other types of communication traffic able to be carried by known telecommunication protocols.

The server 12 maintains a database 24 including personal profiles of each of the users of the mobile communication devices 18, 20 and 22, group relationships 28 characterising the various communication groups formed using the system 10, crowd data 30 characterising communications to be received by users of the mobile communication devices 18, 20 and 22 from within a defined geographical zone and location based context data 32 for definition of those geographical zones.

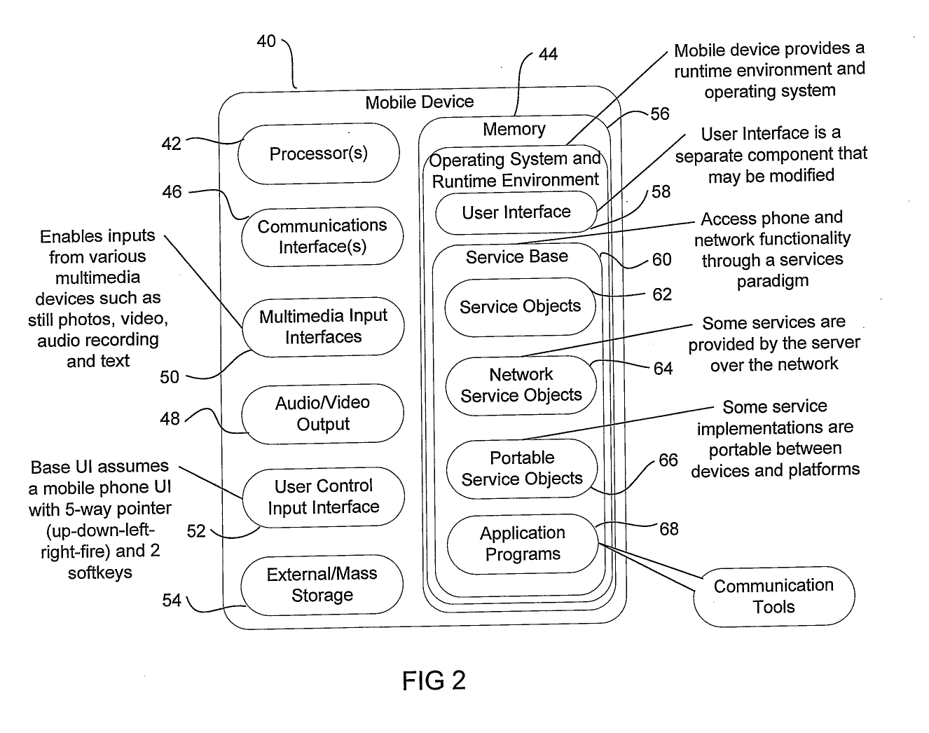

Each of the mobile communication devices 18, 20 and 22 can be implemented as a cellular telephone, personal digital assistant (PDA), smart phone or other suitable communications device. FIG. 2 illustrates selected components of an exemplary mobile communications device 40. The mobile communications device 40 includes one or more processors 42, a memory 44, a communications interface 46, audio/video output devices 48, multi-media input interfaces 50, a user control input interface 52 and optionally external mass storage device 52.

The memory 44 includes an operating system and run time environment 56. The operating system and run time environment 56 includes a user interface 58 for controlling user interface functionality in response to inputs from the user control input interface 52. The operating system and run time environment 56 also includes a service base 60 to enable access to phone and network functionality through a services paradigm. The service base 60 includes service objects 62, network service objects 64 for accessing services provided by the server 12 and portable service objects 66 for accessing service implementations that are portable between mobile communication devices and platforms.

The processor 42 is configured to perform any operations required by the mobile communication device 40. For example, if configured as a cellular telephone, the processor 42 includes telephone processes that enable communications to be transferred over a cellular telephone network. Operating system and run time environment 56 and application programs 68 stored in the service base 60 are executed on processor 42. The application programs 68 may include any type of firmware or software that include a series of instructions and can be executed by using the processor 42 to enable implementation of functionality described herein on one of the mobile communication devices 18, 20 and 22. Particular application programs may also be executed on the processor 42 to enable users of the mobile communication devices 18, 20 and 22 to participate in real time social interactions with other members of groups of one or more users of mobile communication devices.

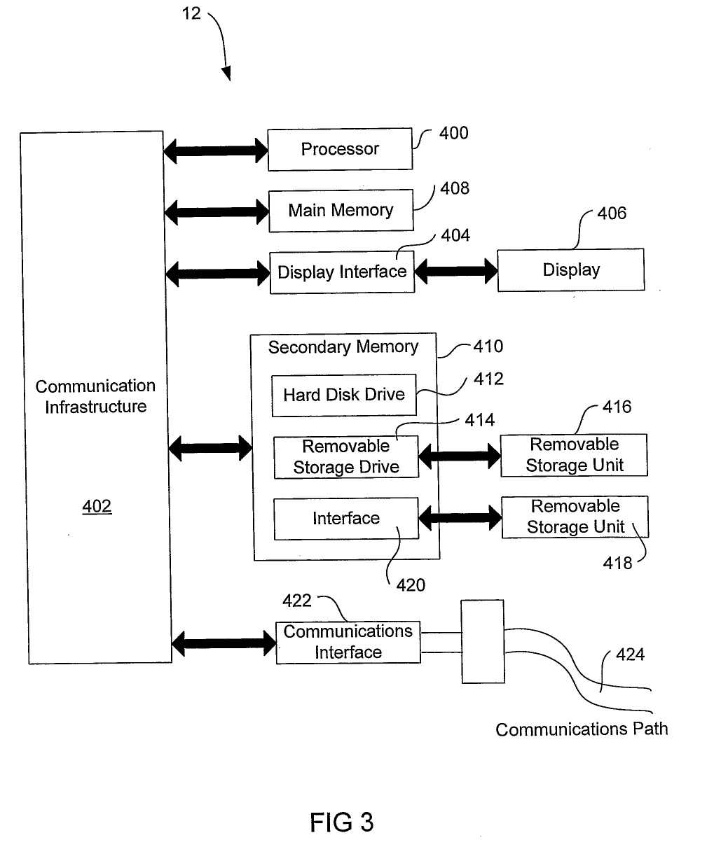

The server 12 similarly includes one or more processors and associated memory including firmware or software application programs that cause the processor or processors to execute functionality described herein. In an exemplary configuration illustrated in FIG. 3, the server 12 includes one or more processors, such as processor 400. The processor 400 is connected to a communication infrastructure 402. The server 12 may include a display interface 404 that forwards graphics, texts and other data from the communication infrastructure 402 for supply to a display unit 406. The server 12 may also include a main memory 408, preferably random access memory, and may also include a secondary memory 410.

The secondary memory 410 may include, for example, a hard disk drive 412, magnetic tape drive, optical disk drive, etc. A removable storage drive 414 reads from and/or writes to a removable storage unit 416 in a well known manner. The removable storage unit 416 represents a floppy disk, magnetic tape, optical disk, etc.

As will be appreciated, the removable storage unit 416 includes a computer usable storage medium having stored therein computer software in a form of a series of instructions to cause the processor 400 to carry out desired functionality. In alternative embodiments, the secondary memory 410 may include other similar means for allowing computer programs or instructions to be loaded into the server 12. Such means may include, for example, a removable storage unit 418 and interface 420.

The server 12 may also include a communications interface 422. Communications interface 422 allow software and data to be transferred between the server 12 and external devices. Examples of communication interface 422 may include a modem, a network interface, a communications port, a PCMIA slot and card etc. Software and data transferred via a communications interface 422 are in the form of signals 330 which may be electromagnetic, electronic, optical or other signals capable of being received by the communications interface 422. The signals are provided to communications interface 422 via a communications path 424 such as a wire or cable, fibre optics, phone line, cellular phone link, radio frequency or other communications channels.

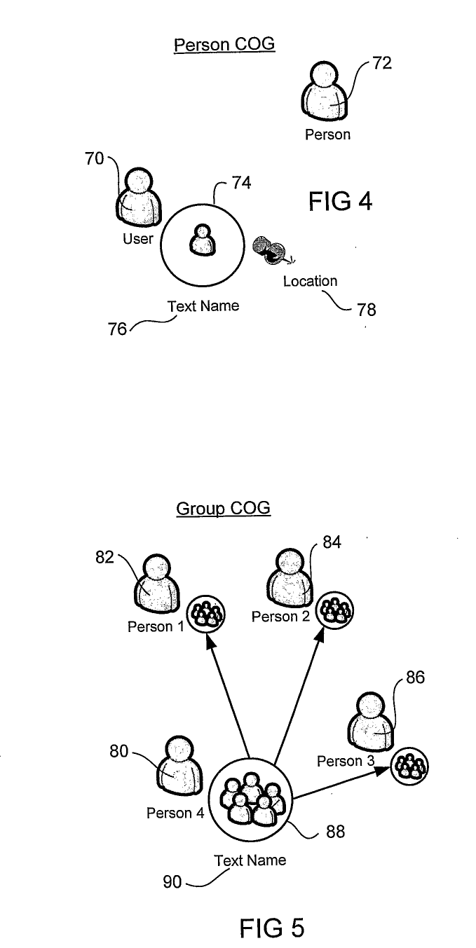

The first of the user communication groups with which a mobile communication device user is able to communicate is shown in FIG. 4. This figure shows a user 70 of a first mobile communications device and a user 72 of another mobile telecommunications device with whom the user 70 wishes to communicate. The user 72 is known to the user 70. The communications group shown in FIG. 4 is called a Person Communications Group, or Person COG.

The mobile communications device of the user 70 is provided with a communication tool for communicating with the mobile communications device of the user 72. The communication tool is a software application forming part of the application programs 68 that includes an indication of the communication group—in this case, a graphic element 74— and optionally a text name element 76 and a location element 78 representative of the geographical location of the mobile communication device of the user 70.

A second communication group with whom a user 80 may wish to interact is shown in FIG. 5. This communication group is called a Group COG. As is the case with the communication group shown in FIG. 3, the user 80 has an existing relationship with other users 82, 84 and 86 within the Group COG. In this case, the communication tool provided on the mobile communication device of the user 80 includes a graphic element 88, and optionally a text name 90. Upon establishment of the Group COG by the user 80, a communication tool enabling communication of a user or other users forming part of the Group COG is transmitted to the mobile communication devices of users 82, 84 and 86 to enable communication between all members of the Group COG.

A third communication group, called a Crowd COG, is shown in FIGS. 6 and 7. In the case shown in FIG. 6, a user 100 need not necessarily have an existing relationship other users 102, 104 and 106 forming part of the Crowd COG. In this embodiment, the Crowd COG is defined by all users 100, 102, 104 and 106 being within a defined geographical zone 108. That geographical zone is preferably defined by the location of the mobile communication device of the user 100. In at least one embodiment of the invention, the radius of the geographical zone 108 is set to be a fixed distance from the determined geographical location of the mobile communications device of the user 100.

In this embodiment, the spatial location of the mobile communication device of the user 100 is used to define the Crowd COG i.e. the geographical zone 108 is defined by reference to that spatial location. It will be appreciated though, that spatial location is just one metadata attribute that can be used to provide context for Crowd COGs.

The mobile communications device of the user 100 is provided with a communication tool for communicating with other users forming part of the Crowd COG. In the context of the present specification, “communication” is intended to embrace both the sending of the communications to mobile communication devices of users in a selected communication group, as well as the receiving of communications from mobile communication devices of users in a selected communication group. This communication tool includes a graphic element 110 and optionally a text name 112. The communication tool also enables the user 100 to determine the boundaries of the geographical zone 108 by setting a radius 114 from the geographical location of the mobile communications device of the user 100. Whilst in the embodiments shown in FIG. 4 to 6 the communication tool provides a visual indication of the communication group, in other embodiments aural, tactile or other indications may be provided.

The communications tool also enables the user 100 to set a number of filters, or rules, in order to enable selective reception of communications from the mobile communications devices of users 102, 104 and 106 forming part of the Crowd COG shown in FIG. 6. In this example, a first filter 116 enables the user to define the media type of communications within the Crowd COG, and a second filter 118 enables the user to define a textual element that matches metadata keywords from communications from the users 102, 104 and 106. It is important for the functioning of the Crowd COG shown in FIG. 6 for the geographical location of the mobile communication devices of users 102, 104 and 106 to be known.

In this example, the mobile communication devices of users 102, 104 and 106 communicate their geographical location to the server 12 to maintain the location based context of each mobile communications device. In other embodiments of the invention, various forms of location determination may be used, including device determination, network identification or by use of an external service.

Unlike the Person COG and Group COG shown respectively in FIGS. 4 and 5, the communication tool enabling communication in the Crowd COG does not require knowledge of one or more network addresses of the mobile communication devices of other users in the communications group. In this case, the communication tool enables the user 100 to participate in the communications group based upon a collection of communications that have some commonality. In this exemplary embodiment, the user 100 need not be identified in the Crowd COG unless the user chooses to do so by adding a moniker or their name to a communication.

In order to send communications within the Crowd COG shown in FIG. 6, the user 100 can use the communication tool to define metadata identifying one or more characteristics of the communication. This metadata can characterise media type, textual elements of the communication or any other desired characteristic of the communication. If the users 102, 104 and 106 have configured communication tools on their mobile communication devices to receive communications within a defined geographical zone that includes the communications device of the user 100, and have selected rules that match the metadata appended to the communication created by the user 100, then that communication will be received by the users 102, 104 and 106. Accordingly, any of the users in the Crowd COG shown in FIG. 6 can configure the Crowd COG communication tool on their mobile communication device as desired, observe communication traffic that is occurring, and then make a contribution to that communication traffic.

Alternatively, as shown in FIG. 7, a user 130 can simply send a Crowd COG communication 132, optionally accompanied by media type metadata 134, textual element metadata 136 or other communication metadata. Provided the location 138 of the mobile communication device of user 130 is known, the communication 132 can form part of an existing Crowd COG or a Crowd COG may coalesce around that message.

As shown in FIG. 7, the location 138 of the mobile communication device of the user 130 falls within a defined geographical zone 140 defined by a user 142. Provided the rules in the Crowd COG communication tool on the mobile communication device of the user 142 have been appropriately configured, the user 142 will receive the message 132.

The location 138 of the mobile communication device of the user 130 also forms part of a second defined geographical zone 144 defined by another user 146. Once again, provided the rules on the Crowd COG communication tool of the mobile communication device of user 146 have been appropriately configured, the message 142 will be received by the user 146. However, the geographical zone 148 defined by a further user 150 does not extend to cover the location 138 of the mobile communication device of the user 130, so the message 132 will not be received by the user 150.

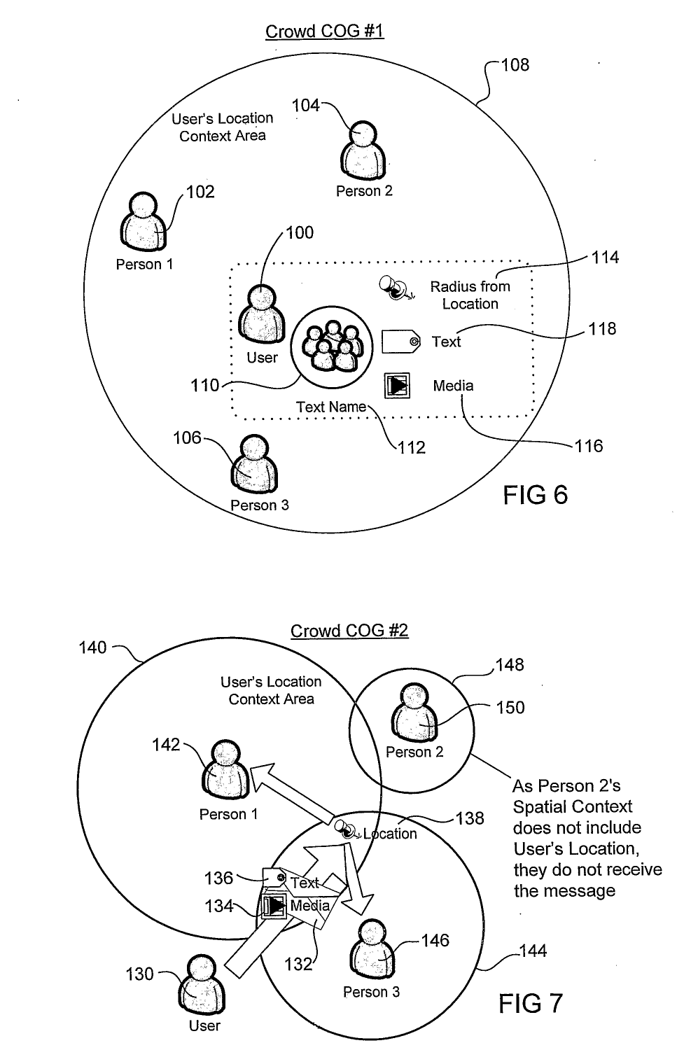

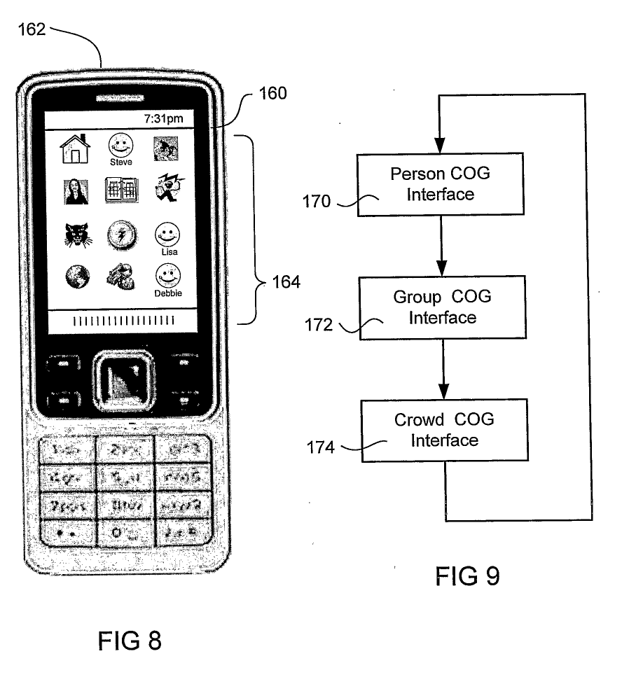

FIG. 8 shows an exemplary representation of a user interface 160 of a cellular telephone 162 showing various graphical elements 164 of communication tools to enable communication between the cellular telephone 162 and mobile communication devices of other users forming part of Person COG, Group COG or Crowd COG. In this embodiment of the invention, graphical elements of communication tools for all Person COGs that have been created by the user of the cellular telephone 162 are grouped on a single display interface, whereas graphical elements of communication tools forming part of Group COGs are grouped together into another interface display, and graphical elements of communication tools forming part of Crowd COGs are grouped together into yet another interface display. As shown in FIG. 9, it is possible for a user to cycle between interface displays 170, 172 and 174 respectively displaying graphical elements of communication tools to enable the user to communicate with Person COG, Group COGs and Crowd COGs.

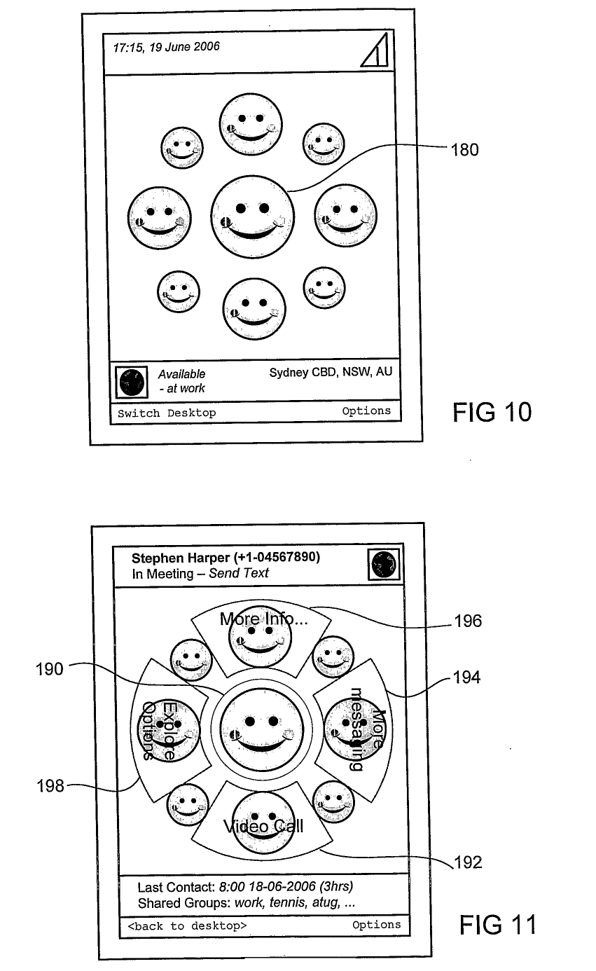

The graphic elements 164 may be displayed in a number of ways. As seen in FIG. 10, activation of the communication tool for a particular Person, Group or Crowd COG may be achieved by touching or otherwise activating the graphical element in question. In this figure, a central graphical element 180 is selected. This then causes the display of an indication of available communication methods for interaction with the selected user communication group, as shown in FIG. 11. Accordingly, a first graphical element 190 is displayed to the user to enable the sending of a text message, a second graphical element 192 is displayed to enable the sending of a video communication. Additional graphical elements 194, 196 and 198 may also be displayed in order to enable the user to drive through a series of menus and perform additional communication or other control functions.

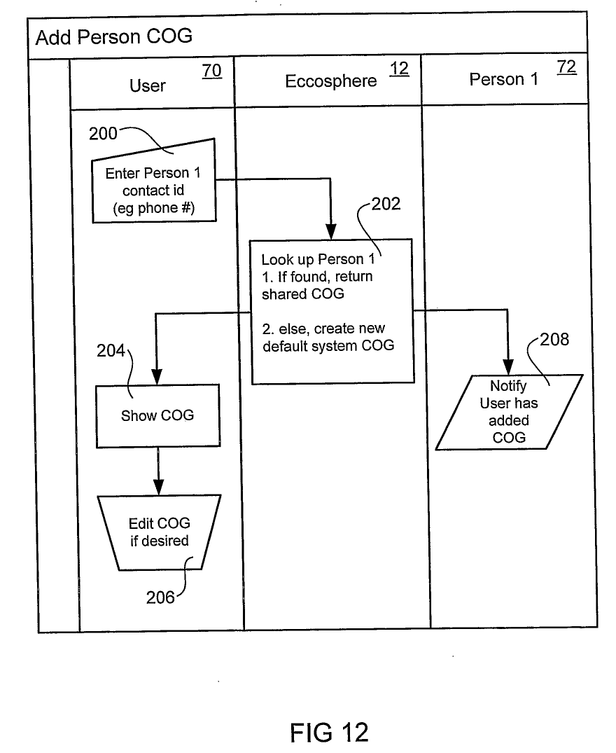

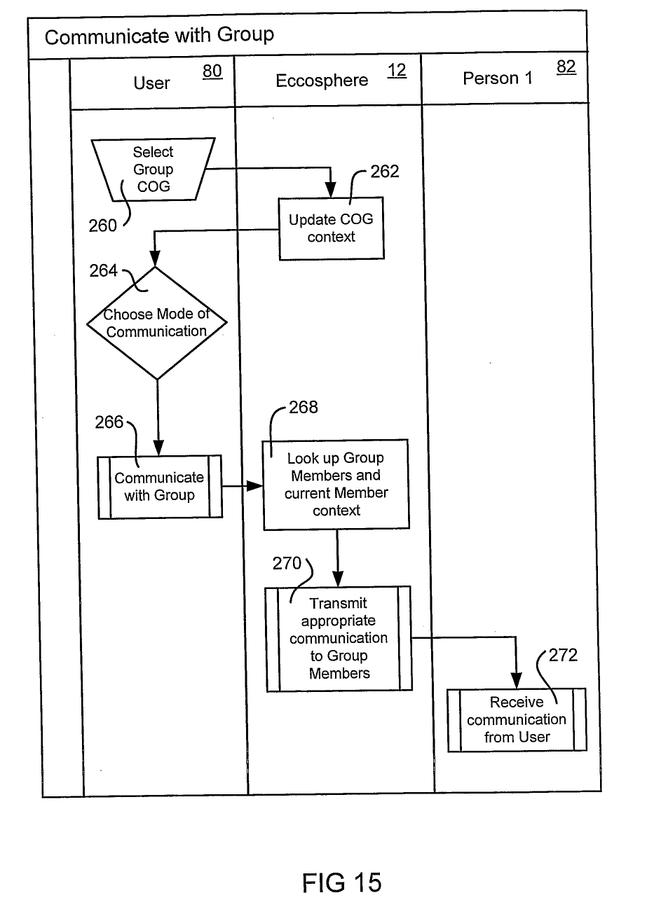

The operation of the system 10 will now be described with respect to FIGS. 12 to 17. FIG. 12 illustrates the functional steps carried out at the mobile communication device of the user 70 shown in FIG. 4, at the server 12 shown in FIG. 1 and at the mobile communication device of the person 72 shown in FIG. 4 in order to create a communication tool for communication with the Person COG shown in FIG. 4. At step 200, the user 70 enters the name, one or more network addresses of the mobile communication device or other identifiers of the user 72. This information is then transmitted to the server 12. At step 202 the server 12 determines whether a person or profile corresponding to the user 72 exists. If so, then a shared communication tool to enable communication with that person is returned to the mobile communication device of the user 70. Otherwise, a default system communication tool to enable communication with that person 72 is created, and then returned to the mobile communication device of the user 70.

At step 204, the graphic element of the returned communication tool is displayed on an appropriately Person COG, Group COG or Crowd COG interface display. The user 70 is able to edit the communication tool if desired at step 206. Once the communication tool has been returned to the user 70, notification is forwarded to the mobile communication device of the user 72 to advise that the user 70 has added a communication tool to their mobile communication device to enable communication with them at step 208.

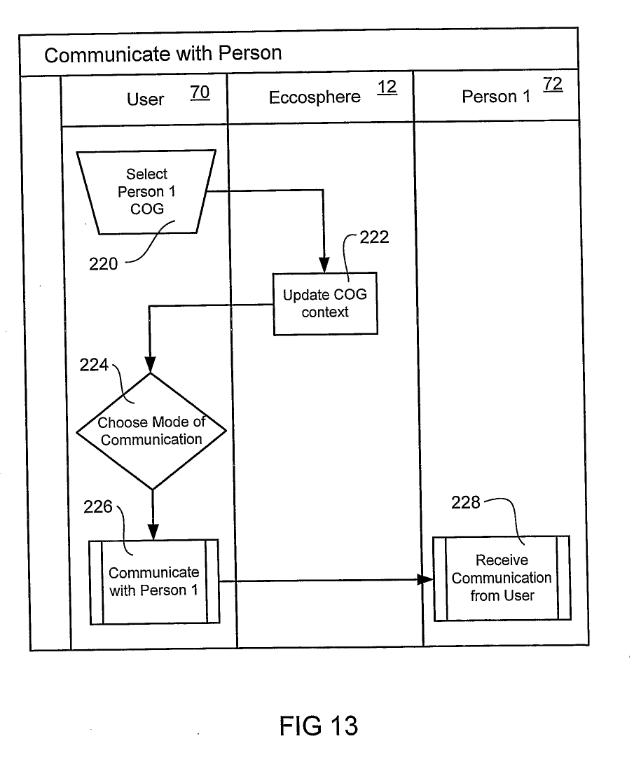

As seen in FIG. 13, in order for the user 70 to communicate with the person 72 via the created Person COG communication tool, the user 70 firstly activates, at step 220 the relevant graphic element of the communication tool displayed on the Person COG interface display of their mobile communication device. The activation of this graphic element is then notified to the server 12 and the location based context 32 of the user 70 is updated. At step 224, the user 70 then chooses a desired mode of communicating with the person 70 (as shown in FIG. 10). At step 226, a communication (text, video, voice etc.) is then initiated by the user 70 and transmitted to the mobile communication device of the user 72 without necessarily being routed by the server 12. That communication is then received by the user 72 at step 228.

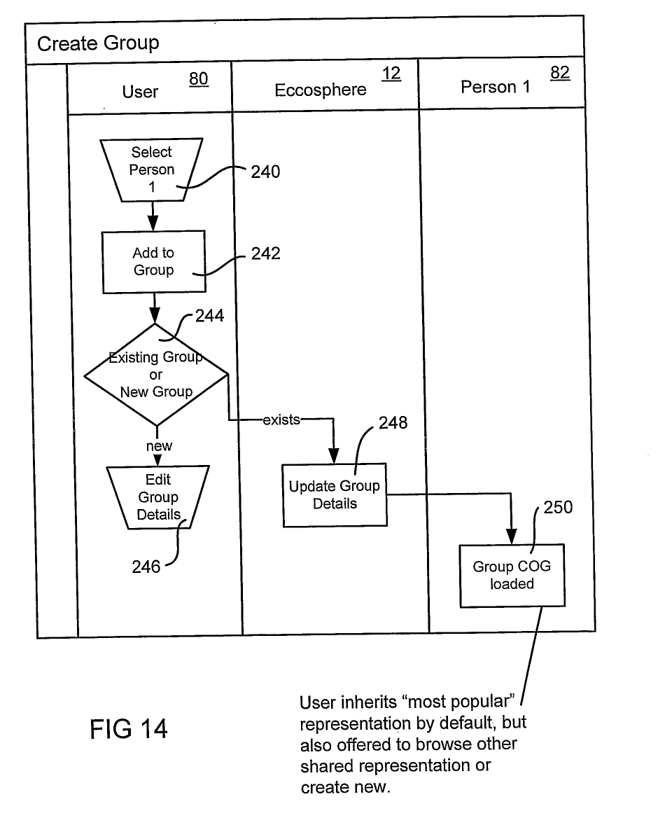

As seen in FIG. 14, a Group COG is formed by the user 80 shown in FIG. 5 in order to create a communication tool for communicating with users 82, 84 and 86, and to enable users 82, 84 and 86 to communicate with the user 80, and with each other, as follows. Initially, the user 80 uses their mobile communication device to select, for example, the user 82 at step 240. The name and one or more network addresses of the mobile communication device of person 82 will have been previously stored in the memory of the mobile communication device of the user 80. At step 242, the details of the user 82 are added to a Group COG. At 244, the mobile communication device of the user 80 determines whether the Group COG exists already or whether a new Group COG is to be created. If a new Group COG is to be created, then at step 246, the user 80 acts to edit details of the Group COG so that a communication tool for enabling communication with other members of the Group COG is created on the mobile communication device of the user 80. Group details are then transmitted to the server 12 and, at step 248, details of the Group COG updated in the group relationships 28 maintained in the memory 24 of the server 12. Once group details have been updated, then a communication tool to enable communication with all Group COG members is transmitted to the user 82 and all other users in the Group COG shown in FIG. 5 at step 250.

In order to communicate with members of the Group COG shown in FIG. 5, the user 80 firstly selects the Group COG communication tool resident on their mobile communication device at step 260. Information that the Group COG communication tool has been activated is then notified to the server 12, and at step 262, the location based context of the mobile communication device of user 80 is updated. At step 264, the user 80 chooses a mode of communication for communicating with other members of the Group COG in a manner shown in FIGS. 10 and 11. At step 266, a communication is created by the user 80 and then transmitted to the server 12. At step 268, the group relationships 28 maintained in the memory 24 of the server 12 are then accessed in order to determine members of the Group COG and the current Group COG member context. At step 270, the server 12 acts to transmit the communication from the user 80 to other members of the Group COG. At step 272, that communication is then received by the mobile communication device of the user 82, as well as by all other members of the Group COG shown in FIG. 5.

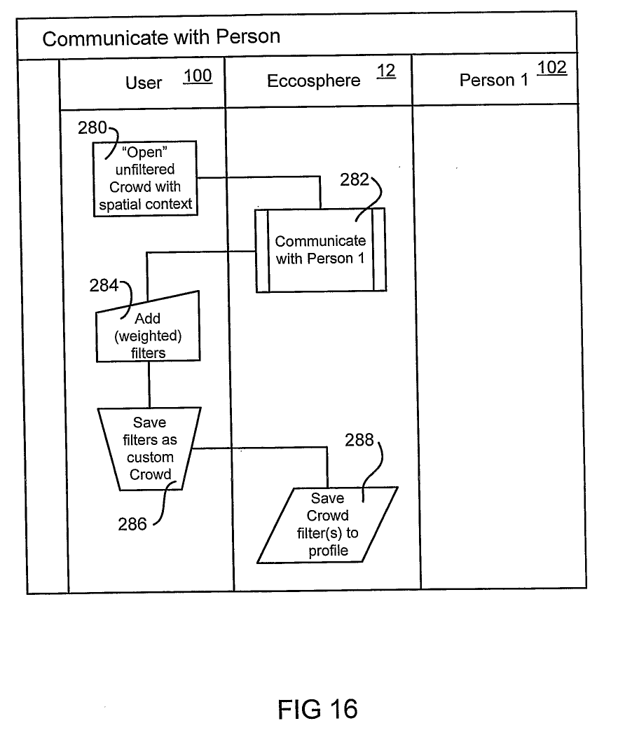

FIG. 16 shows the functional steps carried out in order to create a communication tool to enable communication within a Crowd COG. At step 280, the user 100 shown in FIG. 6 opens a communication tool provided on their mobile communication device. The user 100 acts to define the spatial context of the Crowd COG by setting a defined distance from their current geographical location to be the radius of a defined geographical zone within which Crowd COG members must be located. The spatial context thus defined by the user is then transmitted to the server 12. At step 282, all communications transmitted from within the geographical zone defined by the user at step 280 are transmitted by the server 12 for reception by the mobile communication device of the user 100. At step 284, the user 100 acts to define rules in order to enable the selective reception of communications transmitted by the server 12 at step 282. The rules and defined spatial context of the Crowd COG are then saved on the mobile communication device of the user 100 at step 286 in order to create a communication tool for reception of communications from within that Crowd COG. The Crowd COG rules are then transmitted from the mobile communication device of the user 100 to the server 12 and saved at step 288 to the crowd communications 30 maintained in the memory 24 of the server 12. Optionally, the communication tool for the Crowd COG defined and saved at step 286 may be transmitted to the user 102 or other users within the Crowd COG in question in order to enable reception by all members of the Crowd COG of the same set of communications.

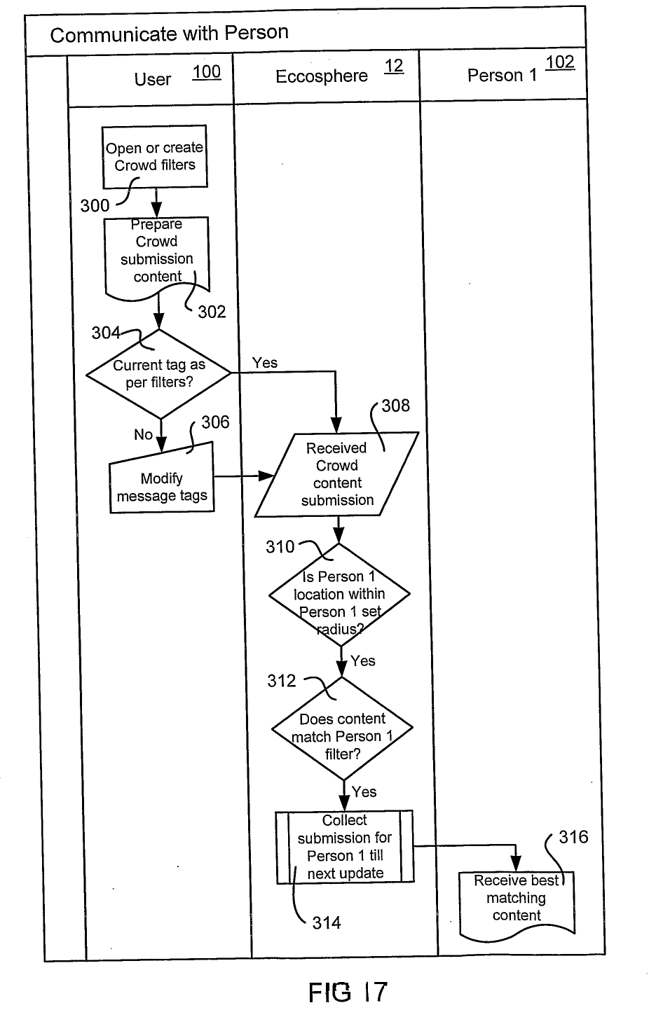

FIG. 17 shows the functional steps involved in the creation and transmission of messages within a Crowd COG to other members of that Crowd COG. In step 300 the user 100 firstly opens or creates rules to enable the selective reception of communications from within the Crowd COG shown in FIG. 6. At step 302, a communication is prepared for submission to the Crowd COG. If it is determined that step 304 that those same rules that were created or opened at step 300 are to be applied as metadata to the communication prepared in steps 302, then that metadata is appended to the communication for transmission to the server 12. If not, then the metadata to be applied to the communication prepared at step 302 is modified at step 306 and then transmitted together with the communication to the server 12.

The communication is received at the server 12 at step 308. If it is determined by the server 12 at step 310 that the mobile communication device of the user 102 is located within the geographical zone defined by the user 100, and if it is determined in the server 12 at step 312 that the metadata associated with the communication match the rules that have been selected by the user 102 for receiving selected communications transmitted within the Group COG, then the communication received at step 308 is collected, at step 314, for subsequent transmission to the user 102. That communication may be transmitted immediately or alternatively one or more collected communications may be transmitted to the user 102 at regular update intervals.

The mobile communication device of the user 102 may be adapted to receive and display all communications transmitted from the server 12. Alternatively, at step 316, if a large number of communications are transmitted due to higher levels of communication activity within the Crowd COG, then the mobile communication device of the user 102 may act to sort received communications and only display those communications whose metadata best matches the rules selected by the user 102.

The above described system of social interaction between users of mobile communication devices replicates group social interactions from the physical world and enables those interactions to take place in a consistent and uniform manner across a range of communication group types.

It will be appreciated that various modifications and/or additions may be made to the above described social interaction system without departing from the spirit or ambit of the invention as defined in the claims appended hereto.

For example, whilst the social interaction system is intended to be operated by users of mobile communication devices, in other embodiments of the invention one or more members of a particular Person COG, Group COG or Crowd COG may be embodied as a fixed communication device, such as a desktop PC connected to the Internet. Information maintained at the server 12 may also be updated and managed from a fixed terminal via the Internet. That fixed terminal may or may not be part of a selected communication group. Moreover, the various functional steps performed in FIGS. 12 to 17 need not necessarily be carried out at the described mobile communication device or server, but may be migrated to other elements of the system shown in FIG. 1 to be carried out.

Furthermore, whilst the term “user” has been used in the foregoing description in relation to physical persons, that term should also be understood as embracing one or more virtual personas. By way of example, a physical person may have a number of personas for use in the above described method of social interaction according to the context of the desired communication. A first persona may be used for communication with friends, whereas a second persona may be used for communication with business contacts. A persona can be either associated with a real entity, or disconnected therefrom. An example of a persona disconnected to the real entity is a persona which is not identifiable as being associated with a physical person.

A number of personas may be associated with a same communications device. In this case, prior to selecting a communication group and communicating with users in that group, selection can be made of a relevant persona for participation in that communication. Each persona may have features that describe them, such as name, descriptors, interests etc, which can be made at one or other or both of the communication device associated with the persona and the server facilitating communications between users in a communication group.

1. A method of social interaction between communication device users across a network, the method including:
at a first communication device, selecting a user communication group of a communication group type corresponding to one of:
(a) a known user;
(b) a group of users with a previously established relationship; or
(c) a group of users with no previously established relationship; and
communicating with users in the selected communication group.

2. A method according to claim 1, wherein
the communicating step includes one or both of:
sending communications to users in the selected communication group; or
receiving communications from users in the selected communication group.

3. A method according to either one of claims 1 or 2, wherein
the user communication group is selected by:
selecting a user communication group type; and
selecting a user communication group belonging to a user communication group type.

4. A method according to claim 1, and further including the step of:
at the first communication device, presenting an indication of the user communication groups available for selection.

5. A method according to claim 4, and further including the step of:
upon selection of a user communication group, presenting an indication of available communication methods for interaction within the selected user communication group.

6. A method according to claim 1, wherein
users in a communication group of type (c) are known to be within a defined geographical zone.

7. A method according to claim 6, wherein
The geographical zone is defined by the location of the first communication device.

8. A method according to claim 1, wherein
a communication within a user communication group of type (c) is accompanied by metadata identifying one or more characteristics of the communication.

9. A method according to claim 8, wherein
the metadata characterises at least one of: media type and one or more textual elements of the communication.

10. A method according to claim 8, and further including the step of:
enabling user selection of the metadata at the first communication device.

11. A method according to claim 1, and further including the step of:
using a communication tool for communicating with users in the selected communication group.

12. A method according to claim 11,
wherein the communication tools provided for communicating with users in communication groups of types (a), (b) and (a) are consistent with each other.

13. A method according to claim 11, wherein for a user communication group of type (a), the communication tool provides at least:
an indication of the user communication group, and
one or more network addresses to enable communication with the known person's communication device.

14. A method according to claim 11, wherein
for a user communication group of type (b), the communication tool provides at least:
an indication of the user communication group, and
one or more network addresses to enable communication with the communication devices of all users in the communication group.

15. A method according to claim 11, wherein
for a user communication group of type (c), the communication tool provides at least:
an indication of the user communication group.

16. A method according to claim 15 and claim 6, wherein
the communication tool further enables user selection of the extent of the geographical zone.

17. A method according to claim 15, wherein the communication tool further provides:
one or more user-selected rules to enable selective reception of communications from users in the communication group.

18. A method according to claim 10, and further including the step of:
using the first communication device to create the communication tool.

19. A method according to claim 10, and further including the step of:
using a communication device not forming part of the selected communication group to create the communication tool.

20. A method according to either one of claims 18 or 19, and further including the step of:
notifying one of more other users in the user communication group of the creation of the communication tool.

21. A method according to claim 10, and further including the step of:
transmitting the communication tool to users of other communication devices in the user communication group.

22. A method according to claim 1, wherein
one or more of the communication devices are mobile communication devices.

23. A method according to claim 1, wherein one or more users are a virtual persona.

24. A method according to claim 23, wherein a plurality of personas are associated with a same communications device.

25. A method according to claim 24, and further including the step of:
selecting one of the personas for communication with the selected communication group.

26. A communication device including a processor and an associated memory for storing software that causes the processor to carry out a method according to claim 1.

27. Software for use with a communication device including a processor and an associated memory for storing the software, the software including a series of instructions that causes the processor to carry out a method according to claim 1.

28. A method for facilitating social interaction between communication device users across a network, wherein at least a first communication device is configure to enable (i) selection of a user communication group of a communication group type corresponding to one of (a) a known user, (b) users in a group of users with a previously established relationship or (c) users in a group of users with no previously established relationship; and (ii) communication with communication devices of users in the selected communication group, the method including:
at a server, receiving from the first communication device data identifying all users in a communication group;
creating a communication tool associated with the communication group; and
transmitting the communication tool to the first communication device for use in selection of and communicating with the communication group.

29. A method according to claim 28, and further including the step of:
transmitting the communication tool to other users in the communication group.

30. A method for facilitating social interaction between communication device users across a network, wherein at least a first communication device is configure to enable (i) selection of a user communication group of a communication group type corresponding to one of (a) a known user, (b) a group of users with a previously established relationship or (c) users in a group of users with no previously established relationship; and (ii) communication with communication devices of users in the selected communication group, the method including:
at a server, receiving from the first communication device data identifying the spatial context of the communication group of type (c); and
transmitting communications from within that spatial context to the first communication device.

31. A method according to claim 30, and further including the step of:
at the server, receiving from the first communication device rules for filtering communications transmitted to the first communication device; and
selectively transmitting communications from within that spatial context to the first communication device.

32. A method according to either one of claims 30 or 31, and further including the step of:
transmitting a communication tool to one or more users in the group in order to enable reception of a same set of communications by those users.

33. A server including a processor and an associated memory for storing software that causes the processor to carry out a method according to either one of claims 28 or 30.

34. Software for use with a server including a processor and an associated memory for storing the software, the software including a series of instructions that causes the processor to carry out a method according to either one of claims 28 or 30.
